(19) United States
(12) Patent Application Publication
(10) Pub. No.: US 2014/0101434 A1
(43) Pub. Date: Apr. 10, 2014

(54) CLOUD-BASED FILE DISTRIBUTION AND MANAGEMENT USING REAL IDENTITY AUTHENTICATION

(71) Applicant: MSI SECURITY, LTD., McLean, VA (US)

(72) Inventors: Janarthanan Senthurpandi, McLean, VA (US); Joseph I. Johnson, Bethesda, MD (US)

(73) Assignee: MSI SECURITY, LTD., McLean, VA (US)

(21) Appl. No.: 13/778,062

(22) Filed: Feb. 26, 2013

Related U.S. Application Data
(63) Continuation-in-part of application No. 13/645,479, filed on Oct. 4, 2012.
Application No. 13/645,479 is a continuation-in-part of application No. 13/661,835, filed on Oct. 26, 2012.

(51) Int. Cl. G06F 12/14

(52) U.S. Cl. CPC G06F 12/1408
USPC 713/150

(57) ABSTRACT

Systems, devices and process for secure storage, retrieval and management of files using cloud-based hosting services are supported with a real identity authentication device and process. Biometric authentication is required for encryption/decryption of files. The real identity authentication processes are integrated with file exchange processes and API's related to the hosting services. Systems for enabling third parties to request encrypted files, and for notifying a file owner of such requests, are supported.

### CROSS-REFERENCE TO RELATED APPLICATIONS

The present application is related to co-pending application Ser. No. 13/645,479, filed on Oct. 4, 2012, titled “REAL IDENTITY AUTHENTICATION” and co-pending application Ser. No. 13/661,835, filed on Oct. 26, 2012, titled “PORTABLE, SECURE ENTERPRISE PLATFORMS.” The subject matter of these applications is incorporated herein in its entirety.

### BACKGROUND

1. Technical Field

The disclosure relates generally to the field of data security and secure data and file storage, distribution and management. More specifically, the disclosure relates to devices, methods and systems for secure file storage and management in distributed or “cloud” computing environments.

2. Background

There have been recent trends in data storage and computing arts to utilize ‘cloud,’ or scalable, distributed, remote computing and storage resources as a platform for computing resources and file and data storage and management. For example, various File Transfer Protocol (FTP) hosting sites exist, as well as synchronizing file storage service provided under the name “DropBox,” which provides a cloud-based synchronizing file hosting and storage service. With such synchronizing file hosting services, a client application, which is typically provided on a user's computer, supports one or more designated folders, the file contents of which may be synchronized with a remote file server and may be accessed and replicated on other computers or mobile devices. Users may drag files to the designated folder and copies of the file are automatically replicated on a cloud storage server and available on other computers authorized by the user.

Existing file hosting and storage services suffer from the drawback of security vulnerabilities. For example, once a user uploads files to the remote service, the integrity and access of those files is out of the user's control, and subject to any security risks and vulnerabilities existing with regard to the hosted service. Additionally, the files could be accessed remotely by an unauthorized user who is in possession of the security credential, i.e., username and password, of the authorized user. Similar risks exist while files and file-related information are in transit, for example, via wide-area network to a remote storage location.

The related applications referenced above disclose secure biometric real identity authentication systems and processes that ensure, through biometric data and unique authentication processes, the real identity of a user attempting to access computing resources. It would be advantageous to integrate real identity authentication functionality, such as that described in the above related applications, into cloud-based file hosting, storage, distribution and management systems.

Accordingly, there is a need in the art for devices, processes and systems that address the aforementioned shortcomings and provide real identity authentication and improved security for cloud-based file and data hosting, storage, distribution and management systems.

### SUMMARY OF THE INVENTION

Aspects of the invention provide for seamless integration of real identity biometric authentication systems, such as those disclosed in related application Ser. No. 13/645,479, with cloud-based file and data hosting, storage, distribution and management systems.

According to aspects of the invention, a cloud hosting services management application (also referred to herein as a “Cloud” application) may be provided on the real identity authentication device (or otherwise available on a hosting platform) to enable encryption of files uploaded to a cloud hosting service and decryption of files downloaded from the cloud hosting service. The Cloud hosting services management application may include a cryptographic services module, upload/download module, settings module and hosting service interface module. The settings module enables the setting of configurations for one or more hosting services subscribed to by the user. The cryptographic services module provides for encryption and decryption of files to be uploaded and downloaded. Once a user has biometrically authenticated and thereby initiates a secure file management session with the cloud storage service, the user may upload, download or otherwise manage files and folders in a secure manner, in which all files transferred are encrypted and content of the files stored on the cloud storage service remain encrypted and not accessible to others. Thus, once a user has authenticated using the real identity authentication device, encryption and decryption of files occurs automatically and seamlessly when the user utilizes a configured hosting service.

Access to encrypted files stored on cloud hosting servers may only be accomplished through the cloud hosting services management application that works in combination with a secure, real identity biometric authentication device. Thus, a user desiring access to the files must prove their real identity using the real identity authentication device, and the device must be configured with a cloud hosting services management application and appropriate credentials to permit the authenticated user to decrypt and access the encrypted files. While the encrypted files may be visible to users through a web browser or other typical application for accessing the hosted files, the contents of the files may not be accessed unless the authorized user is authenticated biometrically and through the client application.

Aspects of the invention also provide for configuration of cloud storage services and servers to interface with remotely located biometric real identity authentication devices. A settings module on the cloud hosting services management application enables an authenticated user or administrator to configure each hosting service. Configuration settings are stored securely on the real identity authentication device. The hosting service interface module may include instructions for interfacing with an application programming interface (API) associated with a cloud hosting service.

Aspects of the invention also provide for file owners—those who wish to control access to files—with the ability to grant a requestor access to encrypted files. An access management module of the cloud hosting services management application may provide this functionality. A requestor may request access to a file from the file owner. The file owner may receive notification, via interface, email or other notification channels, configurable by the user via the access management module, that the third-party requestor is requesting access. The requestor's identity may be verified by their corresponding real identity authentication device, or otherwise, to the file owner, who may then grant access to the requestor. Other related aspects of the invention provide for the granting, by a file owner or author, of one-time access to the third-party requestor whose identity is known and verified using a corresponding real identity authentication device.

### BRIEF DESCRIPTION OF THE DRAWINGS

The features and attendant advantages of the invention will be apparent from the following detailed description, together with the accompanying drawings, in which like reference numerals represent like elements throughout. It will be understood that the description and embodiments are intended as illustrative examples and are not intended to be limiting to the scope of invention, which is set forth in the claims appended hereto.

FIG. 1 illustrates network environment suitable for implementing a system for cloud-based real identity secure data access according to an aspect of the invention.

FIG. 2 is a block diagram showing components of real identity authentication device suitable for supporting secure, cloud-based file access and management according to an aspect of the invention.

FIG. 3 illustrates a functional block diagram of a host platform suitable for supporting a real identity authentication device and cloud-based secure data access and file management according to an aspect of the invention.

FIG. 4 is a flow diagram illustrating exemplary steps in a real identity authentication enrollment process, according to an aspect of the invention.

FIG. 5 is a flow diagram illustrating exemplary steps in a real identity authentication process according to an aspect of the invention.

FIG. 6 illustrates an exemplary network environment suitable for supporting one or more real identity authentication devices, methods and systems according to an aspect of the invention.

FIG. 7 illustrates a block diagram of a cloud hosting services management application and cloud hosting service according to an aspect of the invention.

FIG. 8 illustrates a process for configuring a cloud storage service for integrated operation with a real identity authentication device, according to an aspect of the invention.

FIG. 9 illustrates a process for secure, cloud-based, real identity data access according to an aspect of the invention.

FIG. 10 illustrates a second process for secure, cloud-based, real identity data access according to an aspect of the invention.

FIG. 11 illustrates a third process for secure, cloud-based, real identity data access, including a third-party requestor access, according to an aspect of the invention.

FIG. 12 illustrates overall a process flow of a cloud hosting services management application according to an aspect of the invention.

FIG. 13 illustrates a process flow of an FTP server setting process in a cloud hosting services management application according to an aspect of the invention.

FIG. 14 illustrates a process flow of an account setting process in a cloud hosting services management application according to an aspect of the invention.

FIG. 15 illustrates a process for third-party requestor access to a file owner's files on a cloud storage service, according to an aspect of the invention.

FIG. 16 illustrates a cloud application settings screen of a cloud hosting services management application according to an aspect of the invention.

FIG. 17 illustrates a cloud storage service selection screen of a cloud hosting services management application according to an aspect of the invention.

FIG. 18 illustrates a synchronizing file hosting services configuration screen according to an aspect of the invention.

FIG. 19 illustrates a synchronizing file hosting services sign-in screen according to an aspect of the invention.

FIG. 20 illustrates a hosting service interface screen according to an aspect of the invention.

FIG. 21 illustrates a home screen according to an aspect of the invention.

FIG. 22 illustrates an FTP hosting service interface screen according to an aspect of the invention.

FIG. 23 illustrates a synchronizing file hosting service interface screen according to an aspect of the invention.

FIGS. 24-28 illustrate exemplary user interface screens according to an aspect of the invention.

### DETAILED DESCRIPTION OF THE PRESENT EMBODIMENTS

It will be understood, and appreciated by persons skilled in the art, that one or more processes, sub-processes, or process steps described in connection with the Figures included herewith may be performed by hardware, firmware and/or software. If the process is performed by software or firmware, the software or firmware may reside in software or firmware memory in a suitable electronic processing component or system such as one or more of the functional components or modules schematically depicted in the Figures. The software in memory may include an ordered listing of executable instructions for implementing logical functions (that is, “logic” that may be implemented either in digital form such as digital circuitry or source code or in analog form such as analog circuitry or an analog source such as analog electrical, sound or video signal), and may be embodied in any computer-readable medium for use by, or in connection with, an instruction execution system, apparatus, or device, such as a computer-based system, processor-containing system, or other system that may selectively retrieve the instructions from the instruction execution system, apparatus, or device and execute the instructions. In the context of this disclosure, a “computer-readable medium” may beany medium that may contain, store or communicate the program for use by, or in connection with, the instruction execution system, apparatus, or device. The computer-readable medium may be, for example, an electronic, magnetic, optical, electromagnetic, infrared, or semiconductor system, apparatus or device. Other examples of computer-readable media include the following: a portable computer diskette (magnetic), a RAM (electronic), a read-only memory “ROM” (electronic), an erasable programmable read-only memory (EPROM or Flash memory) (electronic), and a portable compact disc read-only memory “CDROM” (optical).

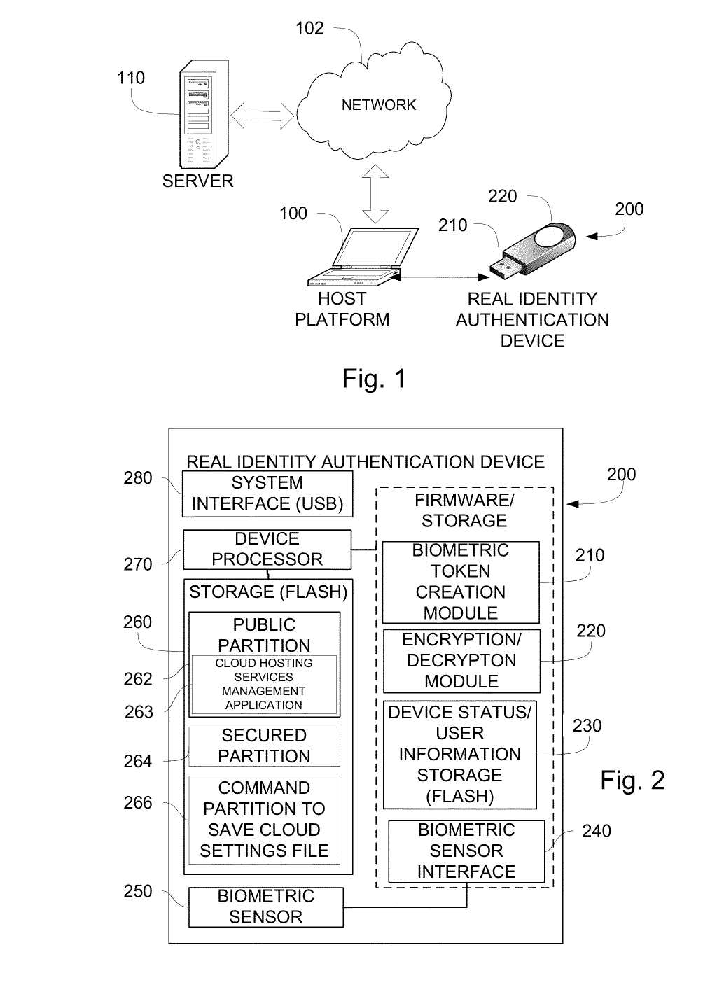

FIG. 1 illustrates a network environment and real identity authentication device suitable for implementing a system for cloud-based, real identity secure data access according to an aspect of the invention. The real identity authentication device 200 may provide functionality for establishing a secure operating system, according to an aspect of the invention, in such a network environment. A client/host platform 100, such as a laptop computer, mobile device or other computing platform may communicate with a wide area network (WAN) 102. One or more server devices 110 may communicate with the client/host platform 100 over the WAN. In accordance with an aspect of the invention, the real identity authentication device 200 may interface via universal serial bus (USB) interface 210 with the host platform 100, and may include an authentication device in the form of a biometric input device 220, which may be a fingerprint recognition device. The authentication aspects of the device may include inventions described in related patent application Ser. No. 13/645,479, titled REAL IDENTITY AUTHENTICATION, the subject matter of which is incorporated herewith in its entirety.

FIG. 2 is a schematic block diagram showing functional components or modules of a real identity biometric authentication device 200 according to an aspect of the invention. The real identity authentication device 200 may include a storage that contains instructions representing a biometric token creation module 210, encryption/decryption module 220, device status/user information storage 230 and biometric sensor interface 240. According to a further aspect of the invention, these components or modules may be implemented by instructions stored in firmware, or other memory or storage, which is not generally accessible to the host platform computing resources. The real identity biometric authentication device 200 may further include a device processor 270, which may be a microcontroller. According to aspects of the invention, device processor 270 may have exclusive access to and control over the components or modules in firmware storage and thus may exclusively process the instructions representing the biometric token creation module 210, encryption/decryption module 220, device status/personal information storage 230 and biometric sensor interface 240 during authentication, without dependence on processing or storage resources of the host platform 100. The real identity biometric authentication device 200 may further comprise a biometric sensor 250, mass storage 260, which may include a public partition 262, which stores a cloud hosting services management application 263, also referred to herein as a “Cloud” application. Storage 260 may also include a secured partition 264 to store secure data, and a command partition 266, which may include a cloud configuration settings file for the cloud hosting services management application 263. The real identity biometric authentication device may also include a host platform (system) interface 280, which may be a USB interface. Device processor 270 may communicate via data bus with the other elements on the device, including firmware/storage, mass storage 260, and host platform interface 280.

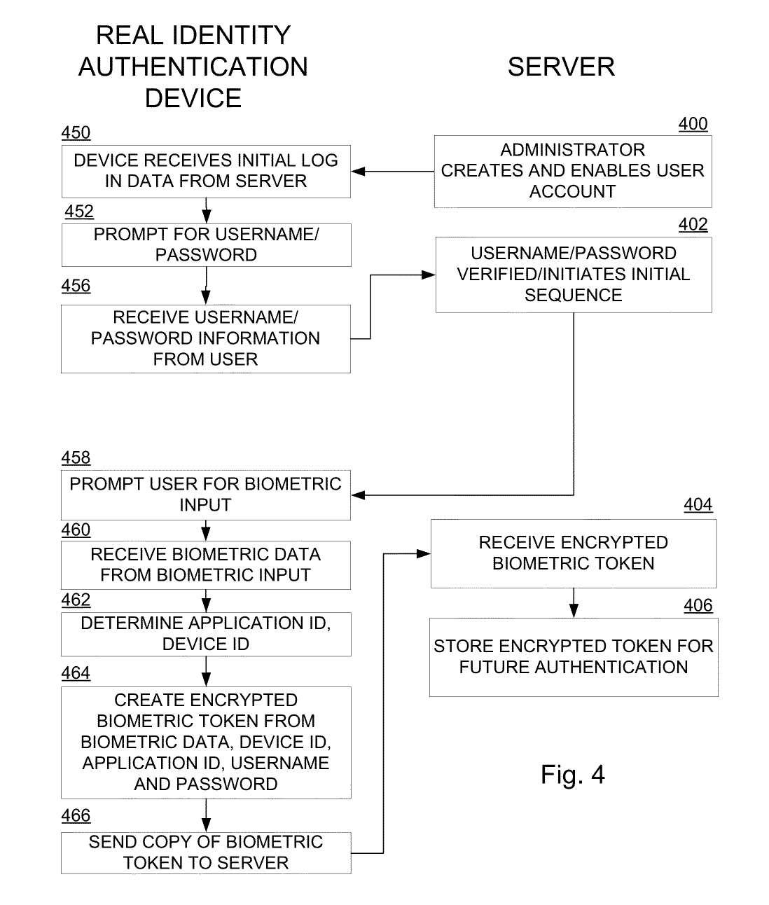

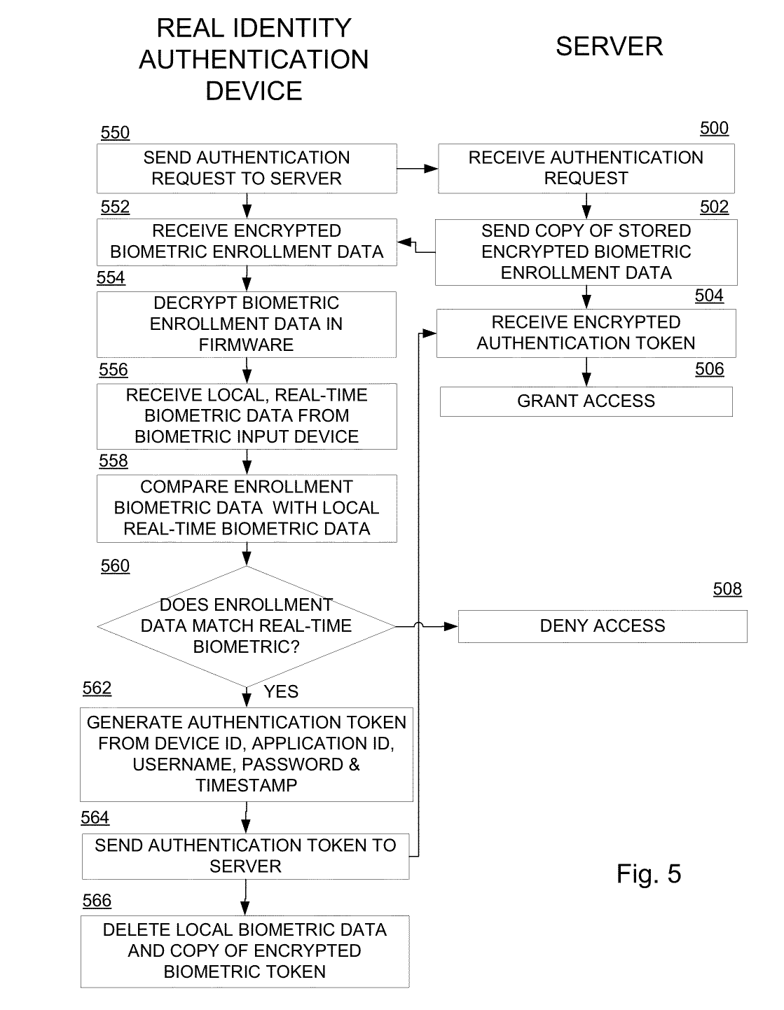

The function of biometric token creation module 210 is to create a unique token or key that incorporates a number of data elements, including biometric data, as will be described in more detail below with reference to FIGS. 4 and 5. The function of encryption/decryption module 220 is to provide encryption and decryption of data input to the module. Encryption/decryption module may utilize any known, symmetric-key encryption technology, such as symmetric-key algorithms defined by Advanced Encryption Standard (AES) 256-bit or even 512-bit encryption standards.

Device status and user information storage 230 may be a flash memory storage and provides a storage area, preferably in firmware or other non-volatile, secure memory or storage, to store information such as device identification data, including MAC address, application identification data, username and password in a secure manner.

The device status section may also include data indicating the enrollment state (i.e., whether there are any enrolled users or not, and whether the enrollment volume limit is exceeded), as well as data indicative of the device name, the name of the device represented in the NETBIOS of the host system, and the date and time that the device was enrolled by a user. The user information section may contain a memory section for each enrolled user associated with the device. An exemplary format may contain an enrollment status indicator, user name information, year, month and date of last login, biometric identification information, access permission information, and associated administrator. According to an aspect of the invention, device status and user information storage 230 is preferably flash memory, which allows true random access. The above storage scheme permits storage for a number of users within a relatively small memory space. For example, each user's information may be represented in a memory section of 512 bytes of data, such that a 512 Kbyte memory space can contain information on up to 99 users.

Biometric sensor interface 240 supports the interaction of biometric sensor 250 with the other components and modules of the real identity authentication device 200, and may include drivers and supporting applications and data for enabling such interaction. According to one aspect of the invention, biometric sensor 250 is a fingerprint recognition sensor for sensing a fingerprint image of a user.

One advantage that will be recognized in real identity authentication devices according to aspects of the invention is that the devices retain flexibility in what type of encryption may be utilized. Since encryption and decryption capabilities are provided by device computing resources within a controlled environment—that is, within the firmware and by the device processor 270 (FIG. 2) on the device itself—enterprises may adopt different encryption/decryption methods and standards by re-tasking the firmware, for example, using a software development toolkit. An associated advantage is that the device storage capacity does not restrict adoption of particular encryption methods. In other words, since devices according to aspects of the invention obtain only a single biometric token from the remote authentication server, and perform encryption/decryption within the firmware on the device itself, large databases of biometric template data are not required to be managed. Moreover, encryption methods that require more computing resources may be utilized without corresponding increase in the storage capacity requirements of the device or authentication server.

It will be recognized that biometric sensor may be any device intended to recognize a biometric parameter. Mass storage 260 may be flash memory which functions to store data such instructions and data for implementing one or more operating systems and one or more applications for the real identity authentication device 200 as well as for the host platform.

Processor 270 functions to access memory or storage and execute instructions onboard the real identity authentication device 200. System interface 280, which may be a USB interface, provides an interface between the real identity authentication device 200 and the host platform 100 (FIG. 1).

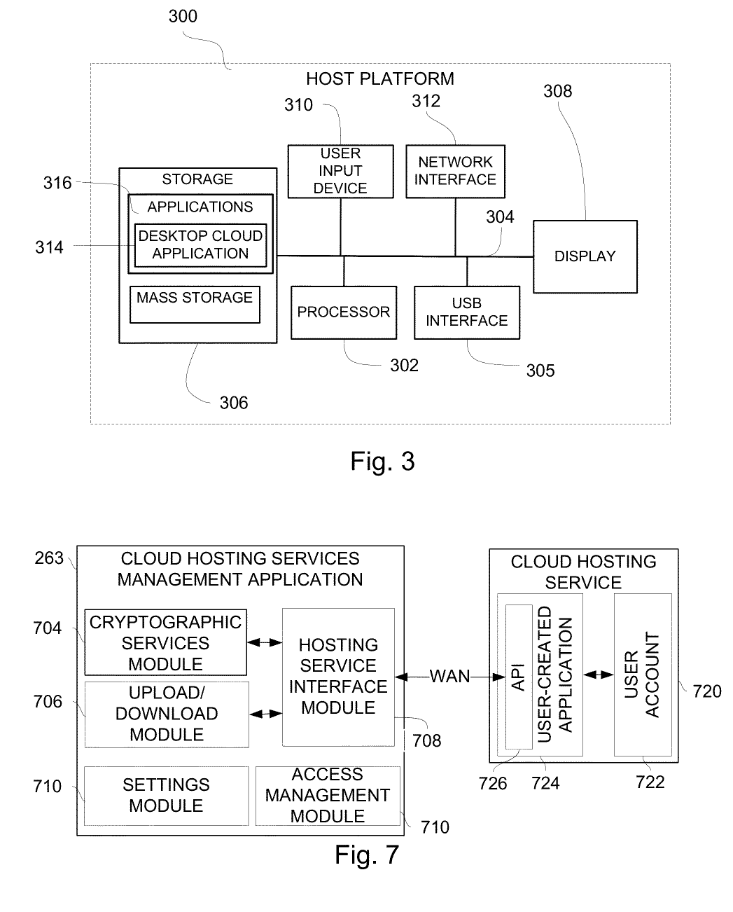

FIG. 3 is a schematic block diagram illustrating elements of a host platform, 300, suitable for supporting an authentication system according to an aspect of the invention. As will be recognized, the server 110 (FIG. 1) may include similar components and architecture to those described herein. Elements of the host platform 300 may include a processor 302, which communicates via an electronic data bus 304 with a storage or memory 306, display 308, user interface 310 USB interface 305 and network interface 312. Processor 302 may execute instructions representing applications 316 stored in storage 306. Such applications may include a desktop cloud hosting services management application 314, also referred to herein as a Desktop Cloud Application. Storage 306 also contains mass storage 316 for storing data and instructions. Real identity authentication device 200 (FIGS. 1 and 2) communicates via the onboard USB interface 280 with the client computer USB interface 305.

It will be recognized that real identity authentication devices according to aspects of the invention may establish a direct and exclusive communication with the remote authentication server. In other words, in accordance with aspects of the invention, the authentication process may occur without use of host platform processing or memory resources utilized in the authentication process performed by the real identity authentication device 200 when authenticating with the remote authentication server. The host platform 100 may provide power, hardware and software support for standard network interfaces and secure communication protocols, such as Secure Socket Layer (SSL) to establish a generally secure communication link between the host platform and a remote server. But the authentication process performed by the real identity authentication device is preferably done independent of host platform processing or memory resources. This is in accordance with the enhanced security capabilities provided by devices according to aspects of the invention. In other words, the device processor 270 (FIG. 2) and firmware components or modules (FIG. 2) preferably provide exclusive support of the interaction with the authentication server to authenticate the user. This is supported by the extended processing capabilities of the device processor on devices according to aspects of the invention.

### Real Identity Authentication Device and Process

FIG. 4 illustrates an enrollment process according to an aspect of the invention. At step 400, an administrator creates and enables a user account. This step may include the creation of a user profile, including user name, address, and other data, which may later be used to verify identity. The administrator is one with suitable access rights to the server data, and may be physically located with the server, or may be remotely located. At step 450, the authentication device receives initial login information from the server. At step 452, the user is prompted for a username and password. At step 456, the device receives the input username and password and this information is sent to the server for verification. If the information is successfully verified, the authentication server, at step 402, instructs the device to prompt the user for biometric input at step 458. The user then interacts with the biometric sensor, which may be a fingerprint sensor, and the resulting biometric data is received by the device at step 460.

At step 462, identifying information for one or more applications being executed, as well as the device ID are determined. At step 464, an encrypted biometric token is created by the biometric token creation module 210 (FIG. 2) and encryption/decryption module (FIG. 2) from the determined device ID and application ID, as well as the biometric data, username and password. At step 466, a copy of the biometric token is sent to the server and received at step 404 and stored at step 406.

According to an aspect of the invention, from the aforementioned process, a unique biometric token, which may include encrypted data indicative of biometric data input by the user locally via the biometric sensor, device identification data, application identification data, username and password, is created by the device in a secure manner, preferably within firmware where it is not susceptible to malware or other security risks. The encrypted biometric token is then sent securely to an authentication server where it is stored for later use in an authentication process, which will be described below.

FIG. 5 depicts an authentication process according to an aspect of the invention. At step 550, an authentication request, which may be generated by a user's input or attempt to access a secure resource, is sent from the real identity authentication device 200 (FIGS. 1 and 2) to the server and received at step 500. In response, at step 502 the server sends a copy of a previously stored encrypted biometric enrollment token to the real identity authentication device. Encrypted data indicative of the biometric token is received at step 552 and decrypted by the encryption/decryption module 220 (FIG. 2) in the real identity authentication device firmware in step 554. A user may then be prompted to interact with the biometric sensor 250 (FIG. 2) to create real-time biometric data, which is received by the real identity authentication device at step 556. At step 558, a comparison is done between the real-time biometric data and the decrypted enrollment biometric data.

Step 560 includes a decision point in which the system determines whether or not the enrollment biometric data matches the real-time biometric data. If not, the process denies access in step 508. If a match is found, the system generates an authentication token at step 562. The generated authentication token may be based upon the device identification data, application identification data, username, password and timestamp. At step 564, the authentication token is sent to the server and received there at step 504. User access is then granted by the server at step 506 and the user is authenticated. At step 566, the local biometric data and copy of encrypted biometric token are deleted for security purposes. Thus, no biometric data is stored on the device after the authentication process.

In the case of multiple users who are associated or registered with a single authentication device, after the above first user has authenticated, conducts a secure authenticated session and logs out, a second user may authenticate with the same device, where the system would perform the above steps for the second user, including sending an authentication request to the remote server from a second user, and the step of receiving an encrypted biometric token from the remote server would include receiving a biometric token associated with the second user.

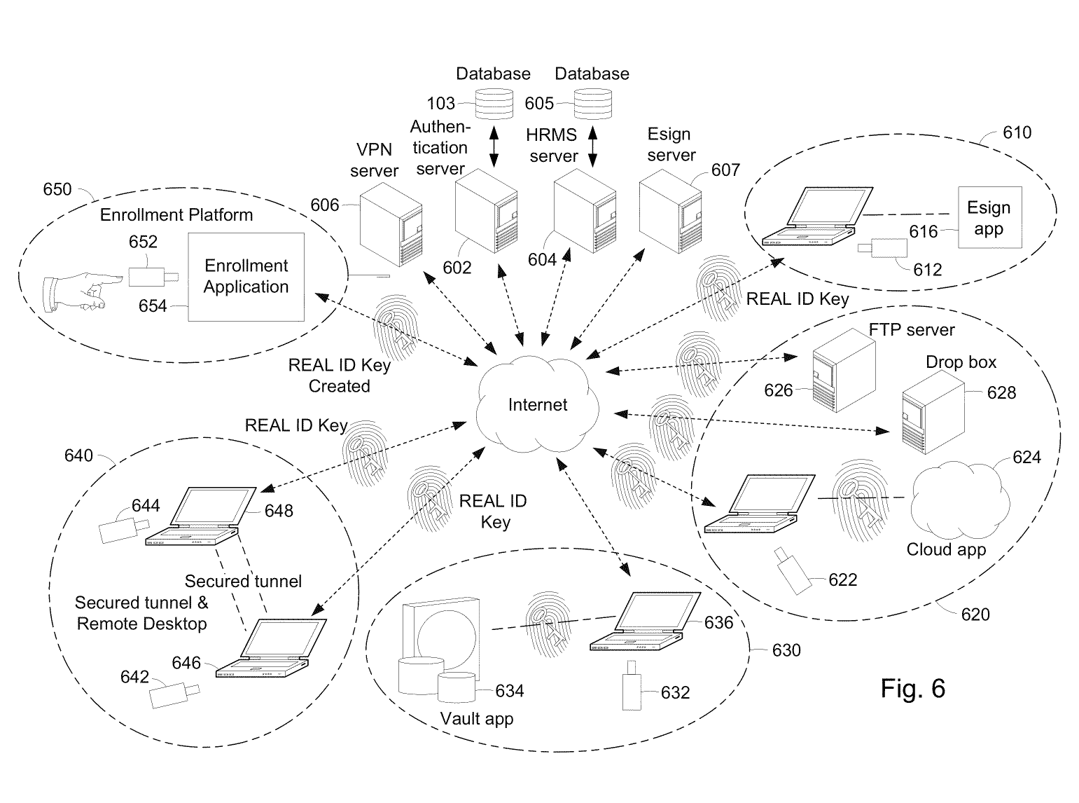

FIG. 6 illustrates a network architecture suitable for supporting one or more real identity authentication devices, processes and systems according to aspects of the invention. Generally, a number of different real identity authentication client environments 610, 620, 630, 640 and 650, each including an associated host computer or platform, and one or more associated applications, may be communicatively coupled to servers 602, 604, 606 and 607 via WAN. Each real identity authentication client environment supports one ore more associated real identity authentication device, 612, 622, 632, 642, 644 and 652. A real identity authentication server 602 provides for management of authentication data and support of authentication processes as described above, and may have an authentication database 603, which stores device information, including device identification data, associated biometric tokens, access levels and other data necessary for authenticating and managing the authentication of users. A Virtual Private Network (VPN) server 606 supports hosting of virtual private networks for one or more of the client environments. A Human Resources Management System (HRMS) server 604 and associated database 605 may store human resource information, such as employee profiles, security information, etc. An e-signature or e-sign server 607 may support electronic signatures by users on client platforms executing an associated e-signature or e-sign client application 610. In this example, real identification device 612 is used in conjunction with an e-sign application 610 to ensure that a user making an electronic signature is the true signatory on a document.

Client environment, such as 620, may support cloud computing functionality, with one ore more cloud applications 624 being supported by one or more associated servers (not shown). A File Transfer Protocol (FTP) 626 server may be provided for file storage and exchange. A server implementing a file sharing system in a drop box configuration, where users may drag and drop files to folder represented on the client platform, and where the folder is automatically synchronized with a corresponding folder or file storage location on the drop box server 628 such that other users may download or share it, may also be provided. In this case, the real identity authentication device 622 is used to support authentication of users desiring to access cloud applications, files on the FTP server, or files stored on or uploaded to the drop box 628.

A file storage vault application 634 may provide for encryption of files stored on local computer 636, such that all files stored on a hard disk or other storage device, are encrypted. In this example, real identity authentication device 632 operates in conjunction with the vault application to ensure that the user accessing stored files is the true, authorized user.

Client hosting environment 640 may include a local secured tunnel environment in which client computers 646 and 648 are communicatively linked via secured tunnel. In this example, respective real identity authentication devices 642 and 644 provide for user authentication and access to the secured tunnel communication functionality.

Client hosting environment 650 may include an enrollment application 654, which enables a user or administrator to enroll one or more associated real identity authentication devices 652 with the authentication server 602, in the manner explained above with regard to FIG. 4.

According to an aspect of the invention, the real identity authentication devices represented in FIG. 6 may represent use of the same authentication device in different client computing environments or may represent the use of respective different devices in different client computing environments. That is, for example, device 612, 632 and 652 may represent the same real identity authentication device used in different client environments 610, 630 and 650.

### Cloud Storage Services

Cloud storage services may include File Transfer Protocol (FTP) services and synchronizing file hosting services, such as DropBox, which provide functionality for synchronizing local and remote files within a designated folder or storage location on the local machine. According to aspects of the invention, an FTP web request library functionality and a synchronizing file hosting library functionality may be integrated within the cloud hosting services management application 263 (FIG. 2), which maybe stored within the public partition 262 on the storage 260 on the real identity authentication device 200. The cloud hosting services management application communicates with one or more cloud hosting services to permit seamless access to these services, while incorporating the advantages provided by the real identity authentication device according to aspects of the invention. The FTP service may include methodologies or functions such as FTP login, retrieving a list of files inside FTP server, and uploading files to and downloading files from the FTP server. The FTP web request library file is integrated into the Cloud application so that the cloud application is able to access the FTP service. The synchronizing file hosting service may require the user to: (i) create a request token (token to access the files stored on the service through a created application), (ii) create an authentication token, (iii) get file lists from the synchronizing file hosting service, (iv) upload files and (v)move files. As will be explained in more detail below, the synchronizing file hosting service may include an API which may be integrated into the cloud hosting services management application 263 (FIG. 2), such that the application key and token key required for access to a user account on the file hosting service may occur automatically and seamlessly once a user has authenticated using the real identity authentication device 200 (FIG. 1).

### Cloud Hosting Services Management Application

FIG. 7 is a schematic block diagram of an exemplary cloud hosting services management (also referred to herein as a “Cloud”) application 263, and cloud hosting service, according to an aspect of the invention. The Cloud application may include a cryptographic services module 704 for implementing cryptographic functionality, including encryption and decryption algorithms. For example, this functionality may be implemented by using the Security. Cryptography, CryptostreamandRijndaelManagedlibraries provided in Microsoft .NET software development Framework, version 4.5. Upload and download of encrypted/decrypted files in a sychronized file hosting service or FTP service may be accomplished through use of the Security.Cryptography namespace and Cryptostream class library. Methods from the RijndaelManaged class library may be utilized for encryption/decryption functionality, such as the CreateEncryptor, method with appropriate arguments for input file location (local system location), output file location (remote server file location, i.e., DropBox or FTP) and password, and the CreateDecryptor method, with appropriate arguments for input file location (remote server file location, i.e., DropBox or FTP) and output file location (local system location) and password.

The Cloud application may also include an upload/download module 706 for managing uploading and downloading of files to and from the hosting service. In the case of FTP hosting services, the FtpWebRequest and FtpWebResponse class libraries of the .NET Framework may be used to create folders (MakeDirectory); rename files (Rename); delete files (Delete); upload files (UploadFile); and download files (DownloadFile). In the case of synchronized file hosting services, such as DropBox, the upload/download module 706 of Cloud application 263 may include functionality implemented by methods such as those associated with the DropBoxClient library, such as the .NET Framework methods, to upload files to DropBox (UploadFileAsync); download files from DropBox (GetFileAsync); create folders (CreateFolderAsync); delete files (DeleteAsync); and move files (MoveAsync).

The cloud hosting services management application may include a hosting services settings module 710 for permitting a user or administrator to configure settings for various hosting services. Cryptographic services module 704 and upload/download module 706 communicate with a hosting service interface module 708, which enables interaction with one or more cloud hosting services. The cloud hosting service 720 may provide user account 722 and a user-created application 724 which may be created on a development platform hosted by the cloud hosting service 720 and which may include or support an application programming interface (API) 726 associated with the cloud hosting service 720. A hosting service interface module 708 of the cloud hosting services management application 263 may make function or method calls to the API and/or the user-created application 724 of the file hosting service to implement certain functions for uploading/downloading files, creating folders, deleting files and folders, etc. The cloud hosting services management application may also include an access management module 712, which enables a user to manage access of other users (file requestors) and notification channels for allowing such users to notify the file owner of desired access, as will be explained in more detail herein.

### Cloud Storage Service Configuration

According to an aspect of the invention, an enterprise, department or group of users may configure a cloud storage service for interfacing with one or more real identity authentication devices. For example, a development team may establish a development account with a commercial cloud storage service, such as DropBox, and develop a cloud application using tools provided by the storage service in a software development kit (SDK). The SDK provides a software framework within which the development team may develop additional code for interfacing a selected system or device with the cloud storage service. Configuration of a cloud storage service and integration of the biometric authentication and security capabilities provided by the real identity authentication device according to an aspect of the invention may be performed according to the processes defined below.

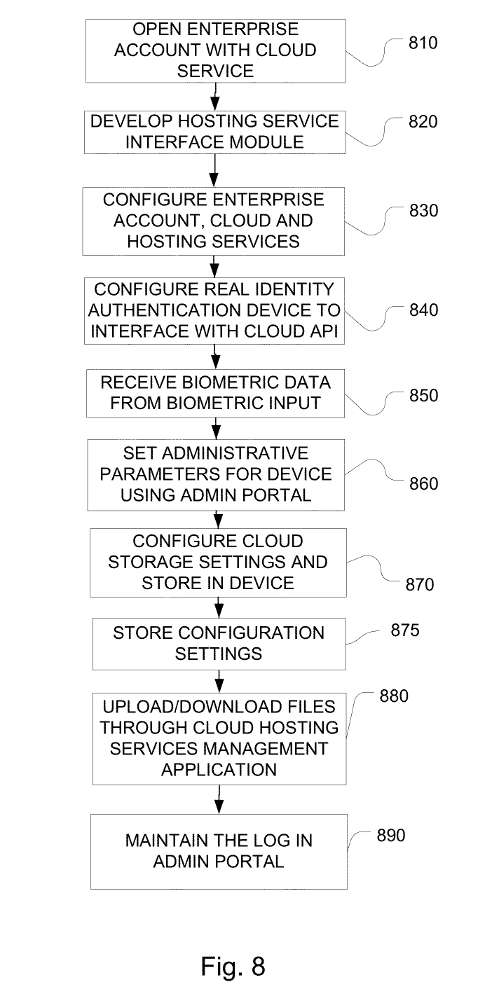

FIG. 8 illustrates a high-level process for configuring a cloud storage service for integrated operation with a real identity authentication device, according to an aspect of the invention. At step 810, an enterprise development account may be created with a cloud hosting service. At step 820, a hosting service interface module, which may be an API, may be developed, as explained above with reference to FIG. 7, to interface with the cloud hosting service. At step 830, the enterprise account, cloud hosting services management application and hosting services interface module are configured. The enterprise account may be a DropBox user account. At step 840, the real identity authentication device is configured to interface with the cloud hosting service API. At step 850, biometric data is received from the user through the biometric input on the real identity authentication device. Upon successful biometric authentication, at step 860, a user with administrative privileges, once authenticated, may set administrative privileges for the real identity authentication device using an administrative portal. At step 870, the cloud storage settings for the real identity authentication device may be configured to enable the user to interface with the cloud hosting services account. Storage setting configuration parameters may include the URL of the cloud storage service and other authentication information, such as username, password and secret application names and keys that may be required for interfacing with the cloud hosting service. The cloud storage settings configuration details are saved in the user's real identity authentication device to enable interfacing with the cloud account. Owing to the advantages provided by aspects of the invention, once the cloud storage configuration settings are configured for a particular cloud storage service, they may be securely stored within the real identity authentication device at step 875 and retrieved automatically during future access the cloud hosting service, thereby providing seamless interaction for the user. At step 880, files may be securely uploaded and downloaded using the cloud hosting services management application executing on the real identity authentication device. At step 890, all user activities may be logged by the real identity authentication device for access by an administrator via the administrative portal. Such activities may include the upload/download history of the files, history of the encrypted files accessed by the users through cloud application, history of the encrypted files accessed through other applications besides the cloud hosting services management application, details of users who may have requested access to encrypted files owned by other users, requests sent by one user to a file owner to provide access to a particular file, time of the file access, etc. This information may be securely stored within cloud hosting services management application.

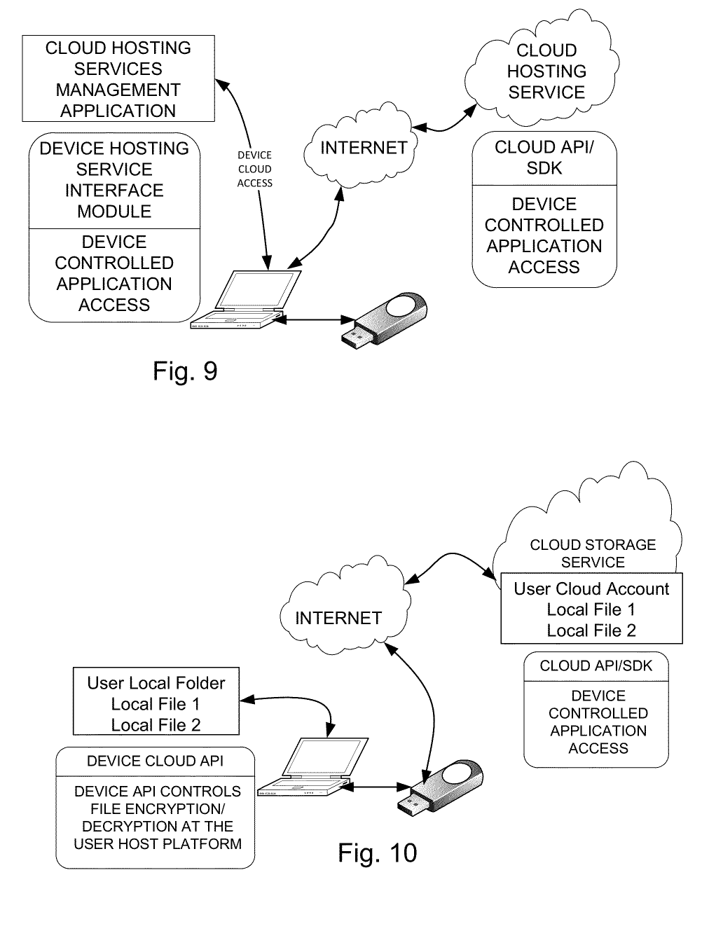

FIGS. 9-11 schematically illustrate the operation of a real identity authentication device and cloud hosting services management application according to aspects of the invention. Referring to FIG. 9, a first route of file storage and retrieval using a cloud application according to aspects of the invention is illustrated. First, a user accesses and authenticates via a real identity authentication device 200. The user then selects the cloud hosting services management application for execution on the host platform 100. The user may perform additional authentication in order to access a particular cloud storage service. A cloud API token, which may be implemented in the device hosting service interface module 708 (FIG. 7), may be enabled based on the authentication requirements for that user's specific account. API communications and file transfers are established between the host platform and the real identity authentication device (microcontroller and AES encryption/decryption module), and then to the user's cloud hosting services account.

According to aspects of the invention, a protocol has now been established such that all files transferred from the user platform to the cloud storage service will be encrypted by the microcontroller and encryption/decryption module in the real identity authentication device 200. The user may now manage their cloud account with seamless encryption/decryption, including functions of opening and creating folders, transferring files. All files transferred according to this protocol will be encrypted and the content not viewable by anyone who lacks real identity authentication credentials or access. If the user accesses the commercial cloud account through his or her normal web interface (without use of the real identity authentication device) then the normal commercial cloud functions are presented and the cloud interface to the encrypted files is not visible or accessible. The user folders and files may be presented (as icons, for example) but encrypted file content is not viewable.

FIG. 10 illustrates a second operational process for encrypting and decrypting files according to an aspect of the invention. In this example, a user may transfer files from the user host platform (e.g., notebook computer) in an encrypted form to the user's cloud account. Alternatively, the user may retrieve files from the user's cloud account to be decrypted locally on the device. Thus, encryption and decryption take place locally. Opening the file directly from within the cloud account (i.e., by trying to access the file via a web interface) would, in this case, result in an unrecognizable encrypted file. Thus, file access must occur via the real identity authentication device. More specifically, a user is enabled to download an encrypted file and decrypt the file on the real identity authentication device directly, that is, without accessing storage or application resources on the host platform. The decrypted file may then be saved on the host platform.

### File Requestor Access Management/Process

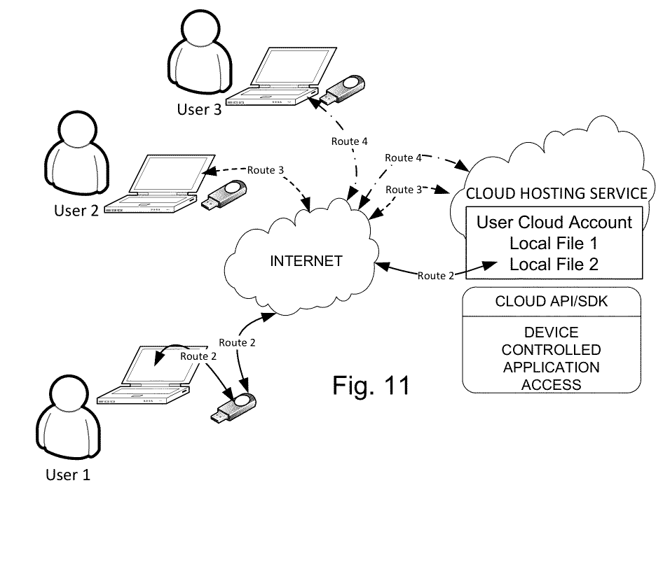

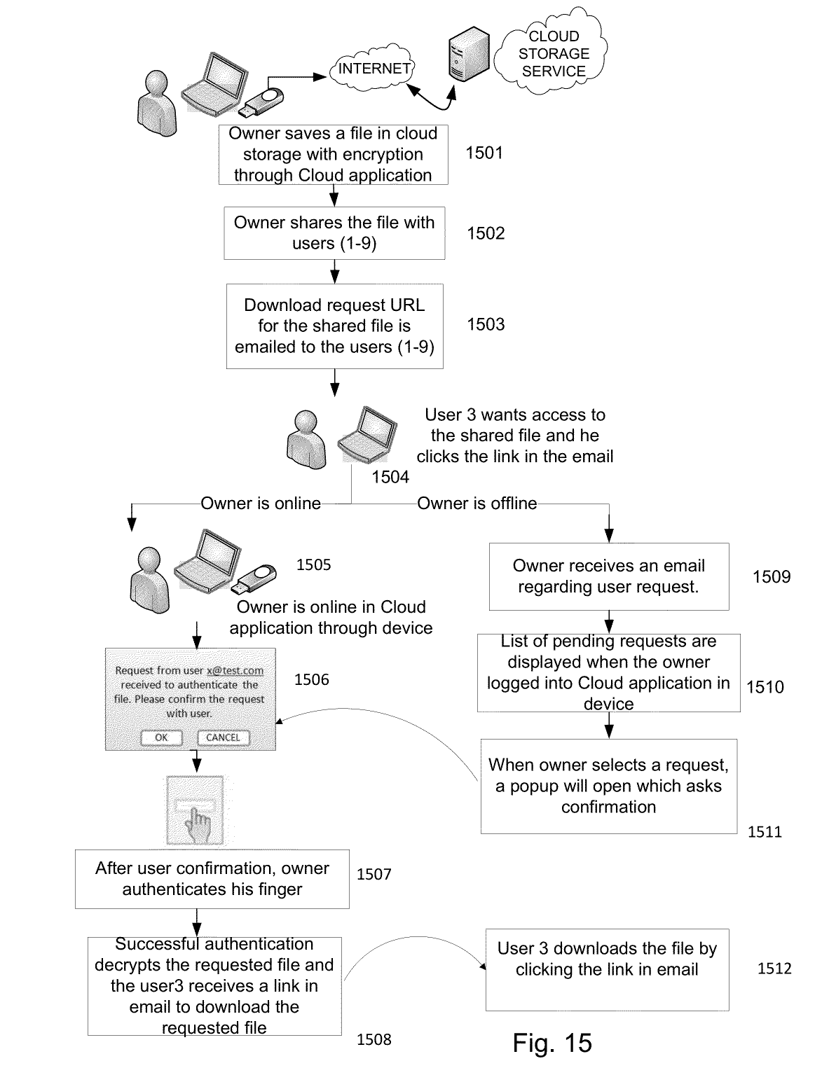

FIG. 11 illustrates an overview of processes for third party requestors to access files owned by an authorized user. Using the Cloud application, a user may enable third-party requestors (User 2 and User 3) to access folders and specific files within specified folders. Each of User 2 and User 3 will have an associated real identity authentication device for decrypting files owned by User 1, for which they are authorized to download and access. User 2 may access the cloud account of User 1 via a typical web interface, assuming User 2 is provided with logon credential for the cloud hosting service (i.e., the account name and password for a shared cloud storage account). While user 2 may be able to view the file icons and folders, the content of each file will be encrypted. Thus User 2 may not access the actual contents of the files without authorization from the file owner (User 1). Similarly, User 3 may view files on the shared cloud account but is unable to access unencrypted files without authorization from the file owner (User 1). Aspects of the invention provide for controlled granting of access to third-party requestors by a file owner, as will be explained in more detail below with reference to FIG. 15.

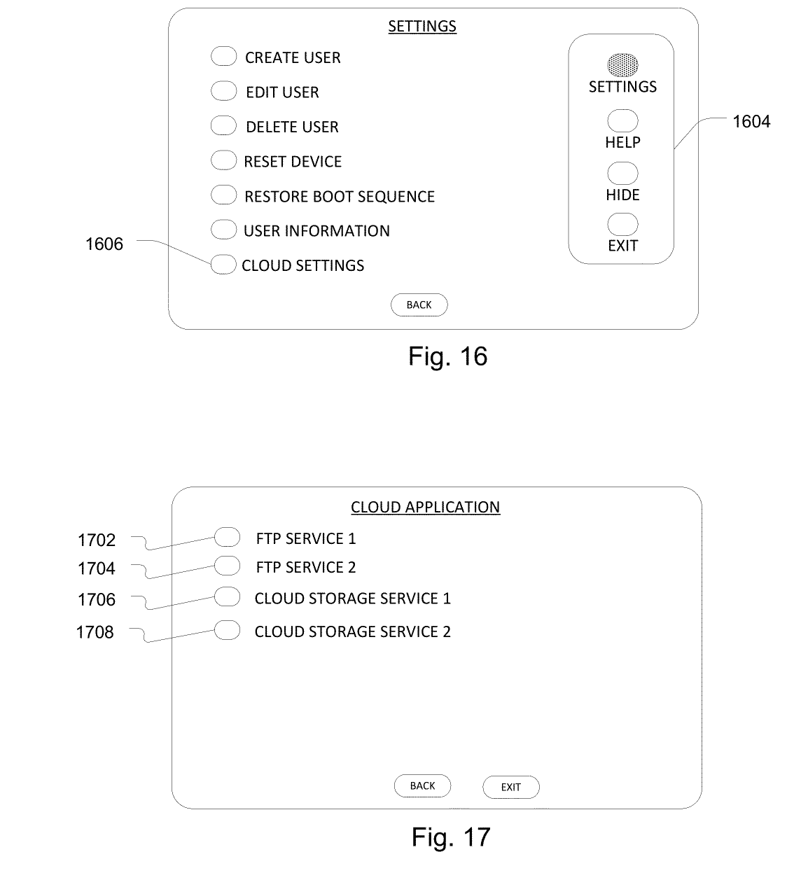

In order to support cloud-based File Transfer Protocol (FTP) file storage and management, an FTP account must first be created on a remote cloud service. Creation of the FTP account may include specifying an FTP server IP address, username and password for a the remote FTP account. This may be done within the CLOUD SETTINGS option on the cloud storage application executing on the host platform (see FIG. 16). Once the remote cloud service FTP account is created, the FTP file management functionality may be accessed by the cloud storage application, executing on the host platform, by clicking on an icon in the user interface to select an FTP service. The FTP service files and folders of FTP server set by the user are displayed inside the device application window. When the user wants to upload a file to a particular folder, he has to select that particular folder and click Upload button present in the FTP Cloud desktop application. According to aspects of the invention, the application encrypts the selected file inside the device and uploads it to the specified folder in FTP. To download that file, user has to select that particular file and click Download option present in the desktop application. The requested encrypted file is downloaded to the device and is decrypted there. These upload and download functions are carried by the FTP service method, which may be called by an FTP web request library of the cloud hosted services management application. A User is able to download the files, which are uploaded only through the cloud application.

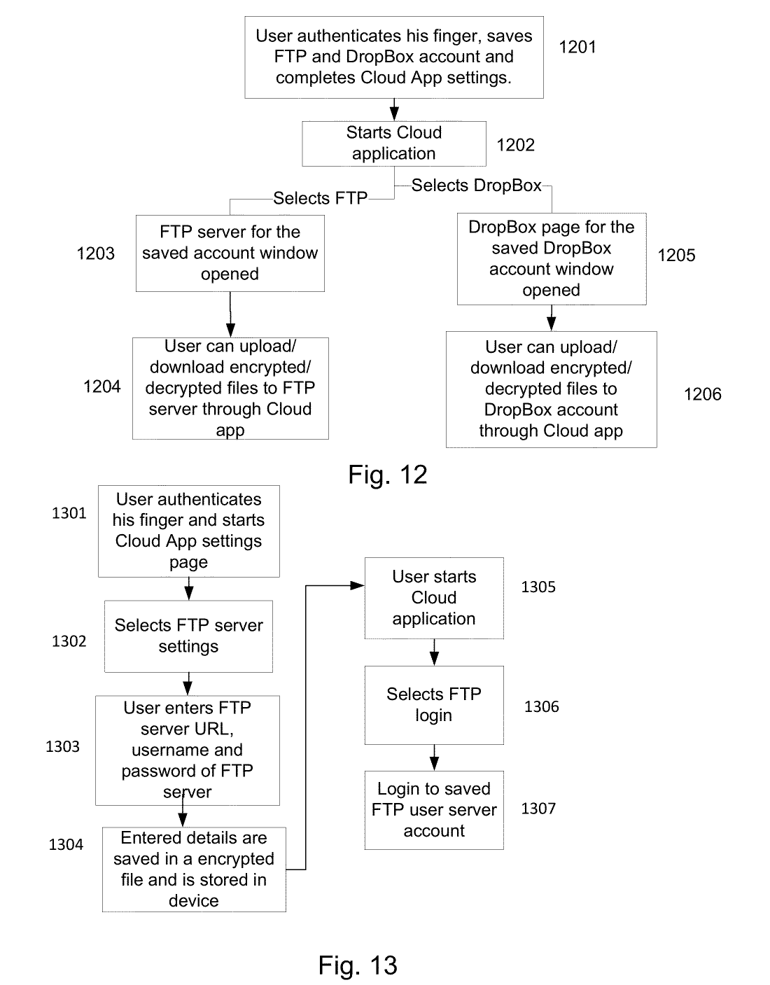

In accordance with an aspect of the invention, in the case of FTP file hosting, encryption and decryption of the files occurs via the Cloud application in a secure environment facilitated by the real identity authentication device 200 (FIG. 1). In other words, without the real identity authentication device and user's real ID authentication, encryption and decryption of the files that are managed (i.e. uploaded, downloaded, deleted, etc.) via the FTP service is not possible. A more detailed process for facilitating the cloud application in the context of an FTP service is explained below with reference to FIGS. 12 and 13.

Similarly, in order to support a synchronizing file hosting service, such as DropBox, a file hosting account must be established through the file hosting service. With that DropBox account, the user needs to create an application (via DropBox protocol) to access the DropBox API. The cloud hosting services management application, according to an aspect of the invention, may provide functionality for the user to create the DropBox API for use with a pre-existing user account. Once the application is created, the user has to note the API key and API secret value of the created application which are the inputs to DropBox API to communicate with the DropBox account files through the desktop cloud application. The application facilitates communication between the DropBox API and the DropBox account.

For example, with a synchronizing file hosting service such as DropBox, the user may be required to input the DropBox account API key and an API secret value, which are provided when the DropBox protocol application is created in the DropBox Cloud settings. After the values are verified, a secured URL for DropBox will be created by the DropBox service. To gain access, the user has to enter his username and password details. On successful verification, the application asks users to confirm the access of his DropBox files by DropBox service. After that, a secure token will be created by the DropBox service which allows access to user's DropBox account through Cloud desktop application. After setup, user has to start the Cloud application from the device application dashboard and select DropBox from it. The user is able to see his DropBox files and folders inside the Cloud application window. When the user wants to upload a file to a particular folder in DropBox, he has to select that particular folder and click Upload button present in the DropBox Cloud desktop application. The cloud application encrypts the selected file and uploads it to the specified folder in DropBox. In accordance with aspects of the invention, encryption of the file occurs within the real identity authentication device itself, and independent of the host computing platform. To download that file, user has to select that particular file and click Download option present in the desktop application. In accordance with another aspect of the invention, the requested encrypted file is downloaded to the device and decryption occurs within the secure environment of the real identity authentication device. These upload and download functions may be implemented by the methods called from an API of the DropBox service. Thus, a user is only able to download and access files that were uploaded through the Cloud application.

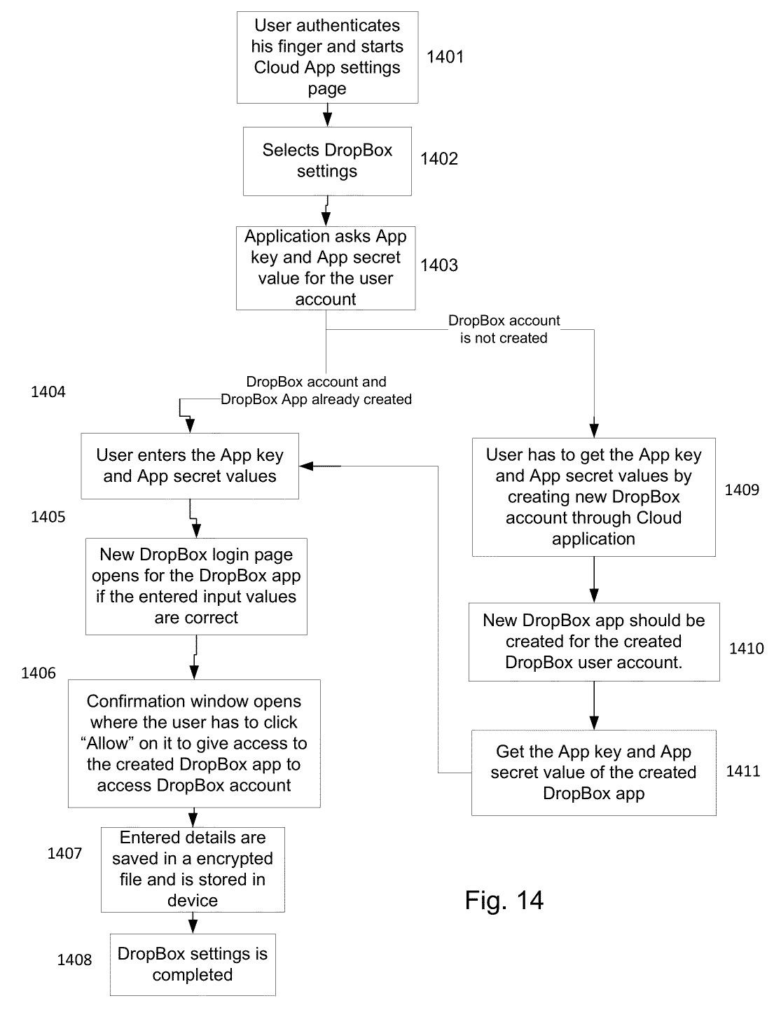

FIG. 12 illustrates an exemplary process performed by a cloud hosting services management application 263 (FIG. 2), according to an aspect of the invention. At step 1201, a user authenticates using his or her fingerprint, or other biometric input, to the real identity authentication device 200 (FIG. 1) to access the initial configuration settings for one or more hosting services, which may include FTP services and/or synchronized file hosting services, such as services provided by DropBox. The configuration of the hosting services will be described below with respect to FIG. 13 (FTP) and FIG. 14 (synchronized file hosting, i.e., DropBox). After setting up the hosting service accounts, the user initiates the hosting services management (“cloud”) application at 1202. The user may be presented with a display, such as that shown in FIG. 17, listing a number of available FTP or synchronized file storage services. If the user selects an FTP service, at step 1203 a window for the appropriate FTP account is opened and a previously stored FTP URL, username & password are passed or binded to the application at 1203. Moreover, the authentication step at 1201 enables the real identity authentication device 200 to seamlessly integrate with the selected hosting service. Thus, according to aspects of the invention, the user can directly access the appropriate FTP server window seamlessly, with single action, i.e., mouse click, without having to authenticate again for each selected hosting service. The user can now upload/download files to FTP server through the cloud application at step 1204. If the user selects a synchronized file hosting service, such as DropBox, an account login screen is presented at step 1205. Many synchronized file hosting services include an application key and secret value that are provided to a user when an account is established. The application key and secret value are unique to the user's account. In accordance with an aspect of the invention, the application key and secret value for the synchronized file hosting service may be passed to or binded with the cloud application, such that the user is not required to enter these values, once the user has biometrically authenticated with the real identity authentication device 200. Thus, the login sequence for the synchronized file hosting service, i.e., DropBox, and the input of the application key and secret value, may occur automatically. At step 1206, the user may download/upload/shared files to his or her synchronized file hosting service account.

FIG. 13 illustrates a more detailed process for configuring FTP service settings in a cloud application. At step 1301, the user authenticates using the real identity authentication device 200 (FIG. 1) and selects the an FTP server settings option at step 1302. As part of the process, an FTP settings window (not shown) opens and permits the user to enter information describing the FTP server URL, FTP username and password at step 1303. According to an aspect of the invention, these entered details are saved in an encrypted file and the file is stored in the secured command partition 266 (FIG. 2) of the real identity authentication device 200 (FIG. 3) at step 1304. The details may be saved and stored as a hidden encrypted file in the command partition. The “Cloud” application may be executed from a CD partition and the secured partition configured into a locked state. Upon initiation of the cloud hosting services management (“cloud”) application at step 1305, and selection of the FTP login at step 1306, the cloud application reads the encrypted file and binds the values within the application and passes them to the FTP server during a login sequence, automatically, at step 1307.

FIG. 14 illustrates a more detailed process for configuring a synchronizing file hosting service, such as DropBox. At step 1401, the user authenticates using the real identity authentication device 200 (FIG. 1), using his fingerprint and obtains access to the cloud application settings page (FIG. 16). At step 1402, the user selects the synchronizing file hosting service settings page. A window (not shown) may prompt the user to enter his an appropriate application key and secret value at step 1403. These values are typically obtained when an account is established with the synchronized file hosting service. In the case where an account is already established, at step 1404, the user enters the application key and secret values. Once the entered values are verified, a new login page for the given app values is opened inside Cloud application window where the user needs to enter his DropBox user account login at step 1405. At step 1406, a confirmation message is displayed where the user may be requested to confirm that the user's DropBox app is requesting access to the user's DropBox account. Once the user confirms access, the DropBox configuration settings are completed. In accordance with an aspect of the invention, at step 1407, the information describing the application key and secret values may be stored in an encrypted file in the command partition 266 (FIG. 2) of the real identity authentication device 200 (FIG. 1).

In the case where a user does not have an established account with the synchronizing file hosting service, the user may create a new account at step 1409. This may be done through an appropriate interface (not shown) in the cloud application. After creating new account, in the case of a synchronized hosting service such as DropBox, the user will typically create a DropBox “app”, which is an application with functionality for accessing the DropBox API. In accordance with an aspect of the invention, the cloud application will have code modules, which implement functionality for accessing the API of DropBox or another synchronized file hosting service. When a developer creates an application for interfacing with the synchronized file hosting service API, there may be a unique application key and secret value associated with the created application. This enables the API of the synchronized file hosting service to recognize the application making function calls to the API. Typically, each call to the API will include the unique application key and secret value. A user will obtain, at step 1411, the application key and secret values once the application is created using the development platform for the particular synchronized file hosting service. Once the application key and application secret value are obtained, they may be entered at step 1404 and the same process continues as described above. The synchronized file hosting service (i.e., DropBox) account setting configuration is then completed at step 1408 and the account details bound to the cloud application, such that entry of the account details will not be required each time the file hosting service is accessed, so long as the user is authenticated using the real identity authentication device 200.

FIG. 15 depicts a process and system that enables file requestors to access files owned by an authorized user, according to an aspect of the invention. As used herein, the term “owned” refers to files that a user (“file owner”) has authored or for which the file owner desires to share a particular file in his cloud account with some list of users. A second user (requestor) may be able to receive a “Download Request link” through email, and on clicking that link sends a request to the file owner to give authentication and grant access to that shared file (download link) Requestor need not necessarily have an associated real identity authentication device, but he or she may want to access one or more encrypted files owned by user 1. It should be noted that the second user may not see all of the files in the file owner's account. Rather, the second user may view only the public shared files of the file owner's account. In this example, the requestor sends a request to the file owner for access to a particular file. When the file owner is online, and authenticated via his real identity authentication device, he will receive a notification of the requestor's request from User 2 from the device application executing on a host platform associated with User 2. For example, the file owner may receive, by email, the URL of the file that the requestor is requesting. The file owner then indicates whether or not he will grant the requestor access to the file. When the file owner is not online, he may have to check his email for the request from the requestor or the file owner can view the request details from the cloud desktop application in his real identity authentication device. Alternatively, an SMS notification can automatically be sent to the owner regarding the request from the requestor. In other words, when the file owner receives a request, he or she, if online, may be notified by a pop-up window message, or, if offline, by email or pending requests. If online, the owner can approve the notification by clicking an appropriate control (i.e., an OK button), and may authenticate using biometric (fingerprint) input to grant access. If offline, after the owner logs into the cloud application, he will see a list of pending requests and may then respond to each one by authenticating and then granting access. Message notification may be managed and configured using an appropriate application on the file owner's host platform, wherein the file owner may specify preferred channels of notification from third party requestors for access to encrypted files. FIG. 15 is a process flow diagram showing the process for third-party requestors to access the files owned by an authorized user. Using the Cloud application, a file owner user may grant access to third-party requestors who have requested access to encrypted files and who have already been authenticated by providing real identity authentication. User 1, who is the owner of an encrypted file, will have an associated real identity authentication device to authenticate his real ID when there comes a request from user 2 or user 3 to access that encrypted file. It should be noted, however, that User 2 or 3 need not to have a real identity authentication device. In that case, these users may simply send a request to file owner for a particular file and the owner validates the identity of these requestors (by traditional methods, such as recognizing voice or asking for identity confirming information), decrypts the encrypted file on the host platform, and sends user the decrypted file.

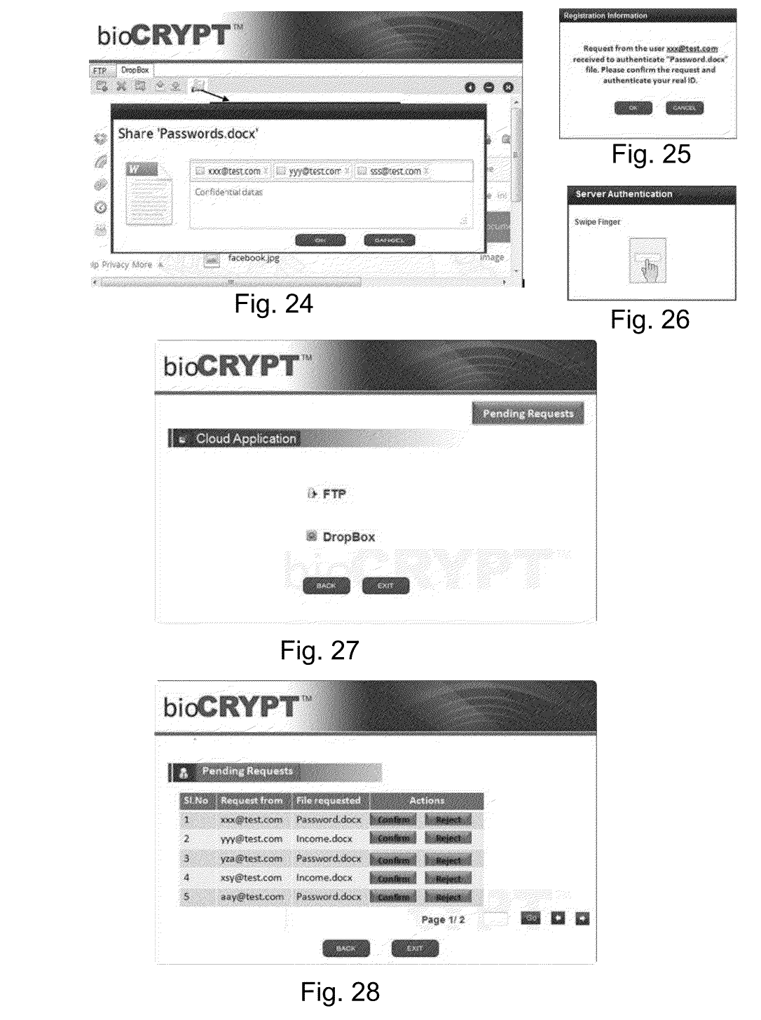

At step 1501, the file owner saves an encrypted file, which may be encrypted within the owner's real identity authentication device, on the cloud hosting service using the Cloud application on the file owner's host platform. Referring additionally to FIG. 24, the owner may share that particular file with a number of users (user 1-9) using a “Share” function provided by the Cloud application, which allows the owner to specify a number of other user's with whom the file may be shared. The share function may be initiated by an appropriate control, such as a share folder icon (FIG. 24) on the user interface, and in this example, the file “Password.doc” is selected and shared by activation of the indicated icon. The email addresses of three users, with whom the owner desires to share the file, are entered in an appropriate field, as shown in FIG. 24. Referring back to FIG. 15, the owner may enter the email address of the users 1-9 in the “Share” link at step 1502. An email containing a request link to the URL to download that particular file is then emailed to the users 1-9 at step 1503.

In the case where User 3 desires to access the shared file, he will click on the link in the request email at step 1504. If the file owner (User 1) is online and accessing the Cloud application on his or her host platform (step 1505), when the request URL is clicked by User 3, at step 1506, the owner is asked to confirm the request of User 3, for example, with a popup notification window that may be displayed on the host platform within the Cloud application of the owner (i.e., desktop) if the owner is online and authenticated through his or her real identity authentication device. FIG. 25 depicts an exemplary notification screen. As an added measure to verify identity of the requestor, the file owner may prompted to contact the requestor by email, phone or some other channel, prior to the owner real ID authentication. At step 1507, the file owner is prompted to authenticate by a pop-up screen such as that shown in FIG. 26 (i.e., with a finger swipe on the real identity authentication device) to confirm his or her approval of the request by User 3 for access to the file. Upon successful authentication by the owner, the Cloud application decrypts the requested file and uploads the decrypted file to a dedicated server that is separate from the cloud account. Then, a link to the decrypted file on the dedicated server will be automatically emailed to User 3 for download at step 1508.

In the instance where the file owner is not online when the requestor requests access to the file, the owner may receive a notification, by email or another channel, about the request from users at step 1509. The owner may then return to his or her host platform and go online, authenticate, and access the Cloud application. For example, referring to FIG. 28, a “Pending Requests” indicator may be displayed to the owner on the home screen for the Cloud application. When the owner clicks the “Pending Requests” control, at step 1510, a list of pending user requests may be displayed to the owner, including the email addresses of requestors, the file requested and an option to “confirm” or “reject” the request as shown in FIG. 28. The owner may process each request by clicking on an associated link, and, at step 1511, a pop-up window (as in step 1506) opens and prompts the owner to confirm the associated requestor's request for the file. The owner authenticates using the same process as described above and emails or other notifications are sent to the requestors with a link to download the decrypted file. At step 1508, User 3 (and any other requestors who have been confirmed by the owner) downloads the decrypted file by clicking the URL in his email at 1512.

FIG. 16 illustrates a main administrative settings screen, which includes a “cloud settings” option according to an aspect of the invention. The administrative settings screen may be accessed via an administrative portal by a user with appropriate administrative privileges, who may select a “settings” option from a main navigation bar 1604. The “cloud settings” option 1606 provides access to enable a user to configure one or more cloud services. Referring to FIG. 17, a cloud application settings screen may provide a number of FTP cloud storage service choices 1702, 1704, as well as a number of synchronizing cloud storage service choices 1706 and 1708. If a user selects an FTP cloud storage service for configuration, additional screens may permit the user to enter the IP address of the FTP server, as well as username and password information. Such information would be entered for each FTP cloud storage service. This information may be saved within the cloud hosting services management application.

For synchronizing type cloud storage services, such as DropBox, configuration of the cloud settings may require additional information. For example, synchronizing cloud storage services, such as DropBox, may require an application key and secret value in order for a remote user to access the hosting services. Initially, an application or “app” may be required to be created by the user as a means to access an API for the cloud storage services. The “app” receives a name when it is created, and in addition, a unique application key is associated with the “app” and a secret identifier is given to the user when the account is created. Using the app name, key and secret identifier, the API for the synchronizing cloud storage service may be accessed by the cloud hosting services management application.

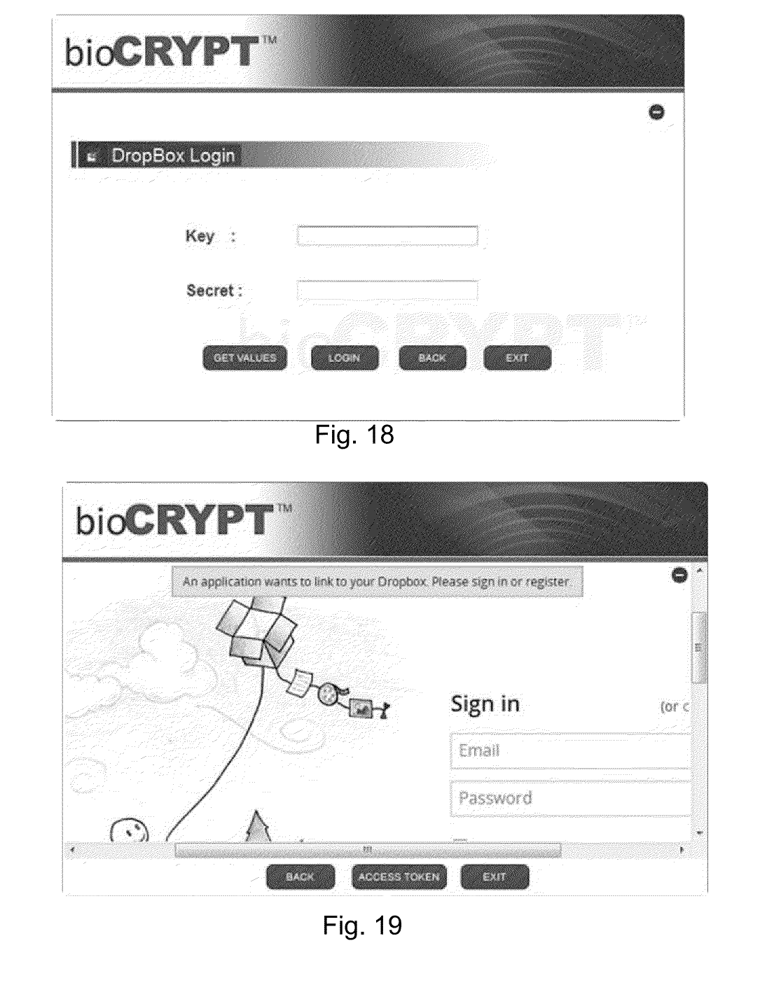

Referring more specifically to FIG. 18, the cloud hosting services management application may request a user to input a unique application key and secret identifier in respective input fields. As described above, this information may be obtained from the remote synchronizing cloud hosting service when an account is created.

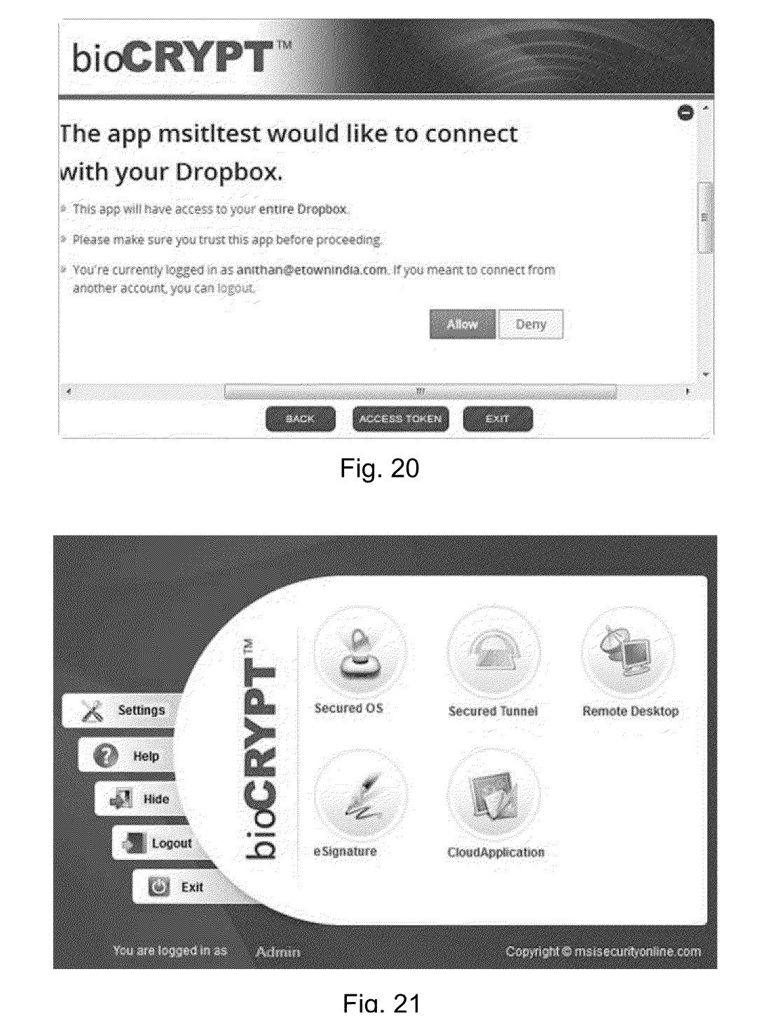

FIG. 19 depicts a logon screen for the synchronizing cloud hosting service. The logon screen may be displayed by a cloud hosting services management application according to an aspect of the invention. The hosting service interface module 708 (FIG. 7) of the cloud hosting services management application 263 will transmit the app key and secret identifier to the synchronizing cloud hosting service. This activity may be transparent to the user. The user is notified that the remote app on the cloud hosting service is attempting to link to the designated folder on the user's local computer and the user is prompted for sign-in information. Upon entry of username and password, the remote app, which was previously created on the cloud hosting services site, will request to interface with the hosting services management application and with the user's designated folder as shown in FIG. 20. Once the user validates the connection (by selecting “Allow”), the cloud service is fully configured and the storage functionality on the cloud hosting service may be accessed via the hosting services management application.

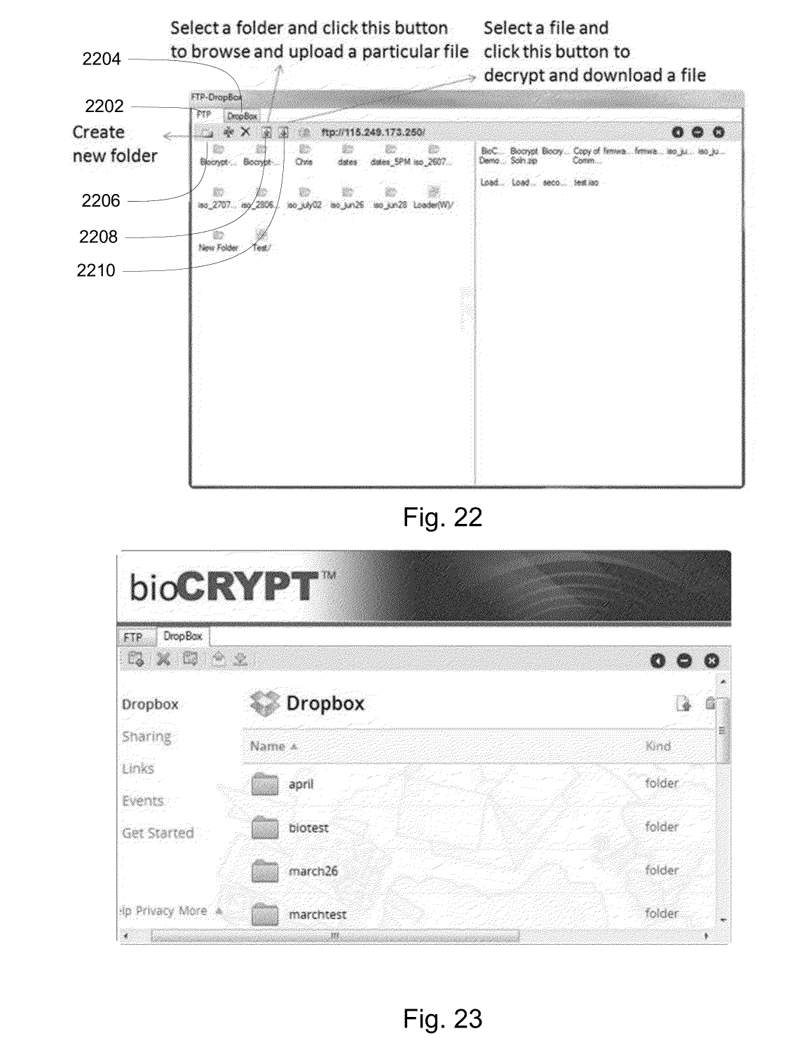

Referring to FIG. 21, once the cloud hosting services management application has been configured for FTP and/or synchronizing file hosting services, the “Cloud” application may be accessed by the user by activating an appropriate control or icon 2102 on a home screen displayed by a desktop application or administrative dashboard supporting the real identity authentication device. Upon selection of the appropriate control or icon, an Cloud application home screen is displayed. An exemplary Cloud application home screen is illustrated in FIG. 22. The home screen may include respective tabs 2202, 2204 for each FTP and synchronizing file hosting service. A toolbar 2206 may provide a control 2208 for browsing, selection and upload/encryption of local files. A download control 2210 may provide functionality for decryption and downloading of files stored on the FTP site. Other controls may be provided for new folder creation and display of the FTP IP address.

Referring to FIG. 23, the cloud hosting services management application may display, within a window associated with tab 2204, a listing of the designated folders to be synchronized with the synchronizing file hosting service. Controls may be provided for creating a new directory or folder. A user may upload files with encryption to the server by selecting the file and the folder to which the file is to be uploaded. According to an aspect of the invention, the selected files are seamlessly encrypted by the cloud hosting services management application within the real identity authentication device and then uploaded to the synchronizing file hosting service server and stored there. Encrypted files may be selected and then a download control may be activated. The selected file is downloaded to a user-specified location on the local/host system. In accordance with aspects of the invention, all upload and download and encryption/decryption operations are performed by the cloud hosting services management application executing on the real identity authentication device. In other words, encryption and decryption of all files occurs exclusively within the secure environment provided by the real identity authentication device. Therefore, without the device, a user is unable to encrypt and decrypt the files on the FTP or synchronizing hosting service server.

It should be understood that implementation of other variations and modifications of the invention in its various aspects may be readily apparent to those of ordinary skill in the art, and that the invention is not limited by the specific embodiments described herein. It is therefore contemplated to cover, by the present invention any and all modifications, variations or equivalents that fall within the spirit and scope of the basic underlying principles disclosed and claimed herein.

What is claimed is:

1. A process for securely storing files on a cloud hosting service comprising the steps of:
providing a real identity authentication device, including a processor, a biometric input device, and a storage containing instructions for,
authenticating a user using the real identity authentication device,
receiving an upload request from the user to upload a file to the cloud hosting service;
upon receiving the upload request, automatically encrypting the file using the real identity authentication device; and
uploading the encrypted file to the cloud hosting service.

2. The process of claim 1, further comprising the step of receiving a download request and, upon receiving the download request, automatically decrypting the file using the real identity authentication device.

3. The process of claim 1, wherein the real identity authentication device performs the steps of:
receiving, using the real identity authentication device, an encrypted server biometric token;
collecting real time biometric attributes, based on biometric interaction of the user with the biometric input device;
comparing the server biometric token and the real time biometric attributes;
creating an encrypted authentication token in response to matching the server biometric token to the real time biometric attributes; and
sending the encrypted authentication token to the remote server to authenticate the user.

4. The process of claim 1, further comprising the step of receiving a request to download a file from the hosting service and in response, automatically decrypting the file securely within the storage of the real identity authentication device.

5. The process of claim 1, wherein the step of uploading the file further comprises the step of interfacing with an application programming interface on the hosting service and wherein encryption of the file is transparent to the user.

6. The process of claim 1, further comprising receiving a request from a file requestor for access to the uploaded file and, in response, granting access to the requestor based on verification of the requestor's identity using a second real identity authentication device associated with the requestor.

7. The process of claim 1, wherein the step of receiving an upload request and the step of uploading are performed by a cloud hosting services management application on the real identity authentication device.

8. The process of claim 1, further comprising the step of displaying a number of cloud hosting service choices to the user and receiving a selection instruction from the user to indicate a selected hosting service.

9. The process of claim 1, further comprising the step of configuring the cloud hosting service using a cloud hosting services management application on the real identity authentication device.

10. A system for securely managing files on a cloud hosting service comprising: a real identity authentication device including: a computer-readable medium for storing data and instructions; a biometric input device for collecting biometric information based on at least one biometric attribute of the user; and a processor for executing the instructions stored in the computer-readable medium, the instructions, including a cloud hosting services management application which, when executed, cause the processor to perform the steps of:
authenticating a user using the real identity authentication device,
receiving an upload request from the user to upload a file to the cloud hosting service;
upon receiving the upload request, automatically encrypting the file using the real identity authentication device; and
uploading the encrypted file to the cloud hosting service.

11. The system of claim 10, further comprising a hosting services interface module on the real identity authentication device for interfacing with the cloud hosting service.

12. The system of claim 10, further comprising an upload/download module on the real identity authentication device, for managing uploading and downloading of files.

13. The system of claim 10, wherein the cloud hosting services management application provides for encryption of the file in a transparent manner, relative to the user.

14. The system of claim 10, wherein the real identity authentication device performs the steps of:
sending an authentication request to a remote server;
receiving an encrypted server biometric token from the remote server;
collecting real time biometric attributes, based on biometric interaction of the user with the biometric input device;
creating an encrypted authentication token in response to matching the server biometric token to the real time biometric attributes; and
sending the encrypted authentication token to the remote server to authenticate the user.

15. The system of claim 10, further comprising an access management module for receiving a request from a file requestor for access to the uploaded file and, in response, granting access to the requestor based on verification of the requestor's identity using a second real identity authentication device associated with the requestor.

16. The system of claim 10, wherein the cloud hosting services management application performs the step of displaying a number of cloud hosting service choices to the user and receiving a selection instruction from the user to indicate a selected hosting service.

17. The system of claim 10, further comprising a settings module for storing settings relating to the cloud hosting service.

18. The system of claim 11, wherein the hosting service interface module includes an API for interfacing with the cloud hosting service.
